(19) United States
(12) Patent Application Publication
(10) Pub. No.: US 2026/0244453 A1
(43) Pub. Date: Aug. 20, 2026

(54) MACHINE LEARNING-BASED GENERATION AND DEPLOYMENT OF DEVICE COMPONENT CONFIGURATIONS IN INFORMATION TECHNOLOGY ASSETS

(71) Applicant: Dell Products L.P., Round Rock, TX (US)

(72) Inventors: Sivakami Velusamy, Bengaluru (IN); Vaishnavi Suchindran, Bangalore (IN)

(21) Appl. No.: 19/055,770

(22) Filed: Feb. 18, 2025

(51) Int. Cl. G06F 9/4401

(52) U.S. Cl. CPC G06F 9/4411

(57) ABSTRACT

An apparatus comprises at least one processing device configured to discover, during a boot process for an information technology asset operating in an information technology infrastructure environment, one or more component devices installed in the information technology asset. The at least one processing device is also configured to generate, for at least a given one of the one or more component devices installed in the information technology asset utilizing at least one machine learning model, a component configuration to be utilized for the given component device. The at least one processing device is further configured to deploy, during the boot process for the information technology asset, the generated component configuration for the given component device in the information technology asset, wherein deploying the generated component configuration comprises controlling at least one of power delivery and thermal dissipation for the given component device.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

As the value and use of information continues to increase, individuals and businesses seek additional ways to process and store information. Information processing systems may be used to process, compile, store and communicate various types of information, including through the use of artificial intelligence (AI) and machine learning (ML). Generative AI, also referred to as GenAI, is a type of AI system that uses ML algorithms, statistical methods, large language models (LLMs), etc. in order to learn from existing data and generate new data. GenAI learns patterns and structures of the existing data and uses them to generate the new data.

### SUMMARY

Illustrative embodiments of the present disclosure provide techniques for machine learning-based generation and deployment of device component configurations in information technology assets.

In one embodiment, an apparatus comprises at least one processing device comprising a processor coupled to a memory. The at least one processing device is configured to discover, during a boot process for an information technology asset operating in an information technology infrastructure environment, one or more component devices installed in the information technology asset. The at least one processing device is also configured to generate, for at least a given one of the one or more component devices installed in the information technology asset utilizing at least one machine learning model, a component configuration to be utilized for the given component device. The at least one processing device is further configured to deploy, during the boot process for the information technology asset, the generated component configuration for the given component device in the information technology asset, wherein deploying the generated component configuration comprises controlling at least one of power delivery and thermal dissipation for the given component device.

These and other illustrative embodiments include, without limitation, methods, apparatus, networks, systems and processor-readable storage media.

### BRIEF DESCRIPTION OF THE DRAWINGS

FIG. 1 is a block diagram of an information processing system configured for machine learning-based generation and deployment of device component configurations in information technology assets in an illustrative embodiment.

FIG. 2 is a flow diagram of an exemplary process for machine learning-based generation and deployment of device component configurations in information technology assets in an illustrative embodiment.

FIG. 3 shows device components of an information technology asset in an illustrative embodiment.

FIG. 4 shows pseudocode for training of a machine learning model configured to generated device component configurations in an illustrative embodiment.

FIG. 5 shows pseudocode for generating and deploying device component configurations utilizing a machine learning model in an illustrative embodiment.

FIGS. 6 and 7 show examples of processing platforms that may be utilized to implement at least a portion of an information processing system in illustrative embodiments.

### DETAILED DESCRIPTION

Illustrative embodiments will be described herein with reference to exemplary information processing systems and associated computers, servers, storage devices and other processing devices. It is to be appreciated, however, that embodiments are not restricted to use with the particular illustrative system and device configurations shown. Accordingly, the term “information processing system” as used herein is intended to be broadly construed, so as to encompass, for example, processing systems comprising cloud computing and storage systems, as well as other types of processing systems comprising various combinations of physical and virtual processing resources. An information processing system may therefore comprise, for example, at least one data center or other type of cloud-based system that includes one or more clouds hosting tenants that access cloud resources.

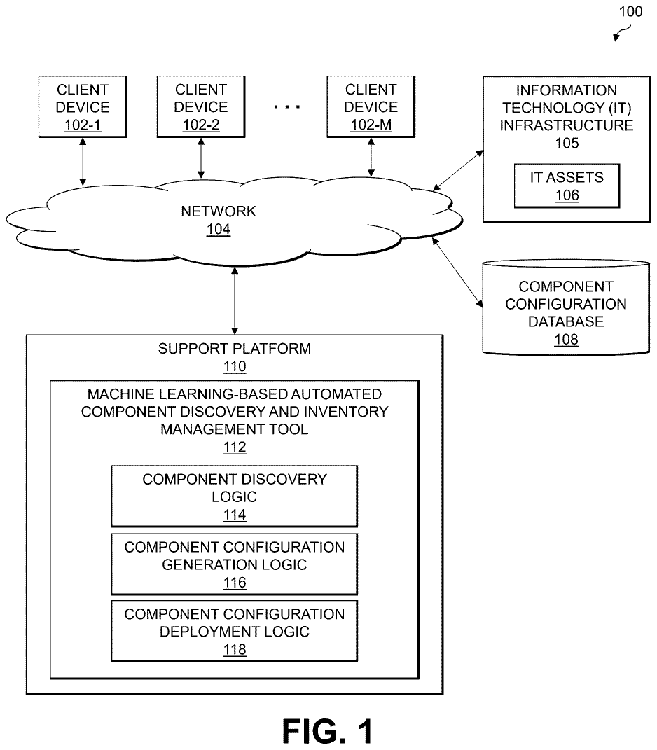

FIG. 1 shows an information processing system 100 configured in accordance with an illustrative embodiment. The information processing system 100 is assumed to be built on at least one processing platform and provides functionality for machine learning-based generation and deployment of device component configurations in information technology (IT) assets. The information processing system 100 includes a set of client devices 102-1, 102-2, . . . 102-M (collectively, client devices 102) which are coupled to a network 104. Also coupled to the network 104 is an IT infrastructure 105 comprising one or more IT assets 106, a component configuration database 108, and a support platform 110. The IT assets 106 may comprise physical and/or virtual computing resources in the IT infrastructure 105. Physical computing resources may include physical hardware such as servers, storage systems, networking equipment, Internet of Things (IoT) devices, other types of processing and computing devices including desktops, laptops, tablets, smartphones, etc. Virtual computing resources may include virtual machines (VMs), containers, etc.

In some embodiments, the support platform 110 is used for an enterprise system. For example, an enterprise may subscribe to or otherwise utilize the support platform 110 for performing streamlined discovery and inventory of device components (e.g., non-standard channel cards) in the IT assets 106 of the IT infrastructure 105 (e.g., an example of a data center or other IT infrastructure environment). As used herein, the term “enterprise system” is intended to be construed broadly to include any group of systems or other computing devices. For example, the IT assets 106 of the IT infrastructure 105 may provide a portion of one or more enterprise systems. A given enterprise system may also or alternatively include one or more of the client devices 102. In some embodiments, an enterprise system includes one or more data centers, cloud infrastructure comprising one or more clouds, etc. A given enterprise system, such as cloud infrastructure, may host assets that are associated with multiple enterprises (e.g., two or more different businesses, organizations or other entities).

The client devices 102 may comprise, for example, physical computing devices such as IoT devices, mobile telephones, laptop computers, tablet computers, desktop computers or other types of devices utilized by members of an enterprise, in any combination. Such devices are examples of what are more generally referred to herein as “processing devices.” Some of these processing devices are also generally referred to herein as “computers.” The client devices 102 may also or alternately comprise virtualized computing resources, such as VMs, containers, etc.

The client devices 102 in some embodiments comprise respective computers associated with a particular company, organization or other enterprise. Thus, the client devices 102 may be considered examples of assets of an enterprise system. In addition, at least portions of the information processing system 100 may also be referred to herein as collectively comprising one or more “enterprises.” Numerous other operating scenarios involving a wide variety of different types and arrangements of processing nodes are possible, as will be appreciated by those skilled in the art.

The network 104 is assumed to comprise a global computer network such as the Internet, although other types of networks can be part of the network 104, including a wide area network (WAN), a local area network (LAN), a satellite network, a telephone or cable network, a cellular network, a wireless network such as a WiFi or WiMAX network, or various portions or combinations of these and other types of networks.

The component configuration database 108 is configured to store and record various information that is utilized by the support platform 110. Such information may include, for example, artificial intelligence (AI) and machine learning (ML) models used for performing streamlined discovery and inventory of device components (e.g., in the IT assets 106 of the IT infrastructure 105), potential generated device component configurations, performance results for the generated device component configurations, monitoring data and feedback associated with utilizing of the generated device component configurations, historical data relating to device component configurations, extracted features and inventories of device components, etc. The component configuration database 108 may be implemented utilizing one or more storage systems. The term “storage system” as used herein is intended to be broadly construed. A given storage system, as the term is broadly used herein, can comprise, for example, content addressable storage, flash-based storage, network-attached storage (NAS), storage area networks (SANs), direct-attached storage (DAS) and distributed DAS, as well as combinations of these and other storage types, including software-defined storage. Other particular types of storage products that can be used in implementing storage systems in illustrative embodiments include all-flash and hybrid flash storage arrays, software-defined storage products, cloud storage products, object-based storage products, and scale-out NAS clusters. Combinations of multiple ones of these and other storage products can also be used in implementing a given storage system in an illustrative embodiment.

Although not explicitly shown in FIG. 1, one or more input-output devices such as keyboards, displays or other types of input-output devices may be used to support one or more user interfaces to the support platform 110, as well as to support communication between the support platform 110 and other related systems and devices not explicitly shown.

The support platform 110 may be provided as a cloud service that is accessible by one or more of the client devices 102 to allow users thereof to perform issue detection and remediation for different users of an enterprise, organization or other entity. In some embodiments, the client devices 102 are utilized by members of the same enterprise, organization or other entity that operates the support platform 110. In other embodiments, the client devices 102 are utilized by members of one or more enterprises, organizations or other entities different than the enterprise, organization or other entity that operates the support platform 110 (e.g., a first enterprise provides support functionality for multiple different customers, businesses, etc.). Various other examples are possible.

In some embodiments, the client devices 102 and/or the IT assets 106 of the IT infrastructure 105 may implement host agents that are configured for automated transmission of information with the component configuration database 108 and the support platform 110 (e.g., regarding discovery and deployment of device component configurations, inventories of device components and associated configurations, etc.). It should be noted that a “host agent” as this term is generally used herein may comprise an automated entity, such as a software entity running on a processing device. Accordingly, a host agent need not be a human entity.

The support platform 110 in the FIG. 1 embodiment is assumed to be implemented using at least one processing device. Each such processing device generally comprises at least one processor and an associated memory, and implements one or more functional modules or logic for controlling certain features of the support platform 110. In the FIG. 1 embodiment, the support platform 110 implements a machine learning-based automated component discovery and inventory management tool 112. The machine learning-based automated component discovery and inventory management tool 112 comprises component discovery logic 114, component configuration generation logic 116, and component configuration deployment logic 118. The component discovery logic 114 is configured to discover, during a boot process for the IT assets 106 operating in the IT infrastructure 105, component devices installed in the IT assets 106. The component configuration generation logic 116 is configured to generate, for one or more of the component devices installed in one or more of the IT assets 106 (e.g., non-validated, non-trusted or otherwise unknown component devices) utilizing at least one machine learning model, component configurations to be utilized for those component devices. The component configuration deployment logic 118 is configured to deploy, during the boot process for the IT assets 106, the generated component configurations, where deploying the generated component configurations includes controlling power delivery and/or thermal dissipation for the component devices.

At least portions of the machine learning-based automated component discovery and inventory management tool 112, the component discovery logic 114, the component configuration generation logic 116 and the component configuration deployment logic 118 may be implemented at least in part in the form of software that is stored in memory and executed by a processor.

It is to be appreciated that the particular arrangement of the client devices 102, the IT infrastructure 105, the component configuration database 108 and the support platform 110 illustrated in the FIG. 1 embodiment is presented by way of example only, and alternative arrangements can be used in other embodiments. As discussed above, for example, the support platform 110 (or portions of components thereof, such as one or more of the machine learning-based automated component discovery and inventory management tool 112, the component discovery logic 114, the component configuration generation logic 116 and the component configuration deployment logic 118) may in some embodiments be implemented internal to the IT infrastructure 105.

The support platform 110 and other portions of the information processing system 100, as will be described in further detail below, may be part of cloud infrastructure.

The support platform 110 and other components of the information processing system 100 in the FIG. 1 embodiment are assumed to be implemented using at least one processing platform comprising one or more processing devices each having a processor coupled to a memory. Such processing devices can illustratively include particular arrangements of compute, storage and network resources.

The client devices 102, IT infrastructure 105, the IT assets 106, the component configuration database 108 and the support platform 110 or components thereof (e.g., the machine learning-based automated component discovery and inventory management tool 112, the component discovery logic 114, the component configuration generation logic 116 and the component configuration deployment logic 118) may be implemented on respective distinct processing platforms, although numerous other arrangements are possible. For example, in some embodiments at least portions of the support platform 110 and one or more of the client devices 102, the IT infrastructure 105, the IT assets 106 and/or the component configuration database 108 are implemented on the same processing platform. A given client device (e.g., 102-1) can therefore be implemented at least in part within at least one processing platform that implements at least a portion of the support platform 110.

The term “processing platform” as used herein is intended to be broadly construed so as to encompass, by way of illustration and without limitation, multiple sets of processing devices and associated storage systems that are configured to communicate over one or more networks. For example, distributed implementations of the information processing system 100 are possible, in which certain components of the system reside in one data center in a first geographic location while other components of the system reside in one or more other data centers in one or more other geographic locations that are potentially remote from the first geographic location. Thus, it is possible in some implementations of the information processing system 100 for the client devices 102, the IT infrastructure 105, IT assets 106, the component configuration database 108 and the support platform 110, or portions or components thereof, to reside in different data centers. Numerous other distributed implementations are possible. The support platform 110 can also be implemented in a distributed manner across multiple data centers.

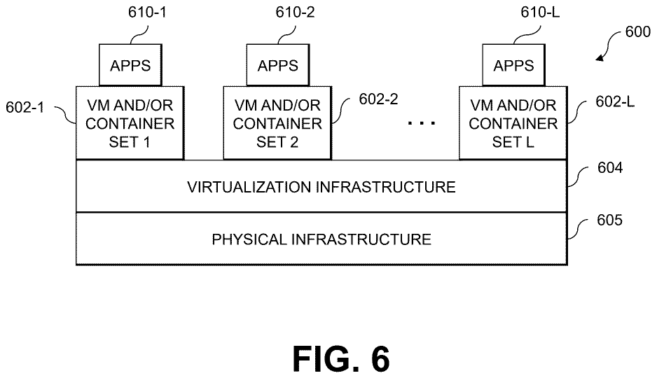

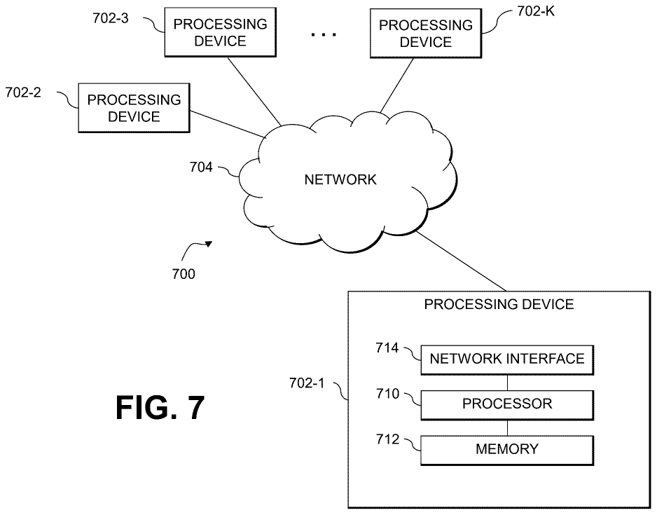

Additional examples of processing platforms utilized to implement the support platform 110 and other components of the information processing system 100 in illustrative embodiments will be described in more detail below in conjunction with FIGS. 6 and 7.

It is to be understood that the particular set of elements shown in FIG. 1 for machine learning-based generation and deployment of device component configurations in IT assets is presented by way of illustrative example only, and in other embodiments additional or alternative elements may be used. Thus, another embodiment may include additional or alternative systems, devices and other network entities, as well as different arrangements of modules and other components.

It is to be appreciated that these and other features of illustrative embodiments are presented by way of example only, and should not be construed as limiting in any way.

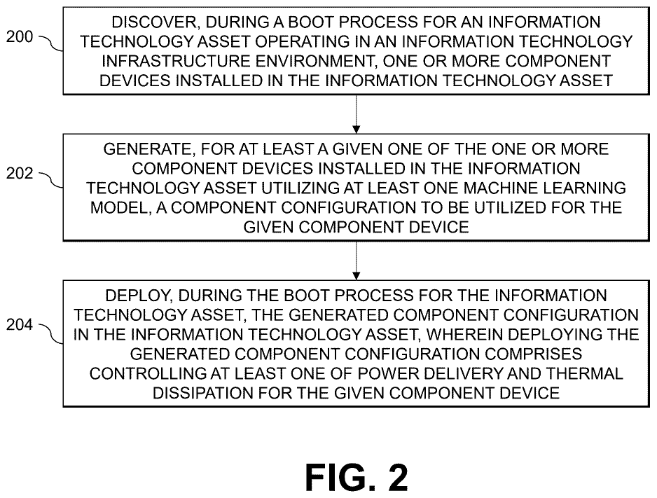

An exemplary process for machine learning-based generation and deployment of device component configurations in IT assets will now be described in more detail with reference to the flow diagram of FIG. 2. It is to be understood that this particular process is only an example, and that additional or alternative processes for machine learning-based generation and deployment of device component configurations in IT assets may be used in other embodiments.

In this embodiment, the process includes steps 200 through 204. These steps are assumed to be performed by the support platform 110 utilizing the machine learning-based automated component discovery and inventory management tool 112, the component discovery logic 114, the component configuration generation logic 116 and the component configuration deployment logic 118. The process begins with step 200, discovering, during a boot process for an IT asset operating in an IT infrastructure environment, one or more component devices installed in the IT asset. The IT infrastructure environment may utilize a data center modular hardware system (DC-MHS) architecture. The IT asset may be a server. The boot process may be a basic input/output system (BIOS) power-on self-test (POST) process. Discovering the one or more component devices installed in the IT asset may utilize a sideband interface to determine device classes of the one or more component devices. The sideband interface may be a modular peripheral sideband tunneling interface (M-PESTI).

In step 202, a component configuration to be utilized for at least a given one of the one or more component devices is generated utilizing at least one machine learning model. The given component device may comprise a channel card which is not validated by a vendor of the IT asset, or may be a non-standard component device not associated with a known component configuration. The at least one machine learning model may comprise a generative adversarial network (GAN) machine learning model. The GAN machine learning model may be trained utilizing historical data collected for a plurality of component devices, the historical data characterizing component device configurations, power consumption, thermal characteristics and operational states of the plurality of component devices.

In step 204, the generated component configuration for the given component device is deployed in the IT asset during the boot process for the IT asset. Deploying the generated component configuration includes controlling at least one of power delivery and thermal dissipation for the given component device. The generated component configuration for the given component device may specify at least one of power usage and thermal dissipation characteristics of the given component device. In some embodiments, deploying the generated component configuration for the given component device includes controlling a speed of one or more fans of the IT asset based at least in part on the power usage and thermal dissipation characteristics of the given component device. Prior to deploying the generated component configuration, one or more fans of the IT asset may be operated at a first speed (e.g., a maximum speed, to account for a worst-case scenario or maximum cooling), and deploying the generated component configuration for the given component device includes adjusting the one or more fans of the IT asset to operate at a second speed, the second speed being less than the first speed.

The particular processing operations and other system functionality described in conjunction with the flow diagram of FIG. 2 are presented by way of illustrative example only, and should not be construed as limiting the scope of the disclosure in any way. Alternative embodiments can use other types of processing operations. For example, as indicated above, the ordering of the process steps may be varied in other embodiments, or certain steps may be performed at least in part concurrently with one another rather than serially. Also, one or more of the process steps may be repeated periodically, multiple instances of the process can be performed in parallel with one another, etc.

Functionality such as that described in conjunction with the flow diagram of FIG. 2 can be implemented at least in part in the form of one or more software programs stored in memory and executed by a processor of a processing device such as a computer or server. As will be described below, a memory or other storage device having executable program code of one or more software programs embodied therein is an example of what is more generally referred to herein as a “processor-readable storage medium.”

The rising adoption of channel cards in data centers creates significant operational challenges, due to the lack of Field Replaceable Units (FRUs) that provide essential data on power, thermal and other characteristics. The DC-MHS architecture provides a flexible and scalable approach for building and managing a physical data center infrastructure. With DC-HMS, there is a possibility that non-validated devices can be plugged in to servers or other IT assets in a data center (e.g., where the non-validated devices are manufactured by a vendor different than the operator of the data center). This can lead to various technical challenges and issues resulting due to this missing support for profiling non-validated devices, including:
1. Increased Power Consumption: servers or other IT assets must run fans at full speed and over-budget for power until the BIOS inventory is completed (e.g., which can take several minutes, such as up to 10 minutes or more to reach the BIOS POST process, and where root of trust processing is performed prior to the BIOS POST process), leading to higher energy usage and increased operational costs.
2. Thermal Management Challenges: without accurate thermal data, maintaining optimal temperatures is difficult. Full-speed fans may prevent overheating, but can cause unnecessary wear and tear on cooling systems.
3. Reduced Efficiency: over-budgeting for power and cooling results in inefficiencies, with servers consuming more power than necessary, leading to wasted energy and higher costs.
4. Potential for Overheating: the absence of precise thermal data risks overcooling (or undercooling), potentially damaging hardware and reducing component lifespan.
5. Delayed Optimization: fine-tuning power and thermal requirements is delayed until the BIOS inventory is completed, prolonging inefficiency and leading to higher operational costs.
6. Performance Impact: worst-case configurations can affect server performance, with overheating or excessive cooling which impacts stability and reliability and potentially causing downtime or reduced performance.
7. Environmental Impact: higher power consumption and inefficient cooling increases the carbon footprint, challenging data centers'sustainability goals.

To summarize, the absence of FRUs in channel cards necessitates interim worst-case configurations, leading to excessive power consumption, thermal management challenges, reduced efficiency, potential overheating, performance impacts, and a larger environmental footprint. Addressing these issues is crucial for optimizing data center operations and achieving sustainability goals.

Illustrative embodiments provide technical solutions for dynamically optimizing server or other IT asset configurations in data centers or other IT infrastructure environments using ML/AI. In some embodiments, Generative AI and historical data are used along with deep learning algorithms for maximizing the optimal server or other IT asset configurations. The technical solutions described herein are thereby able to address technical challenges of conventional approaches, including but not limited to increased power consumption, thermal management, and operational inefficiencies associated with the adoption of non-validated devices (e.g., which may be Open Compute Project (OCP)-compliant lacking FRUs or any well-defined information). The shift to DC-MHS architectures in data centers and other IT infrastructure environments has led to challenges such as increased power consumption, thermal management difficulties, reduced efficiency, potential overheating, delayed optimization, performance impacts and a larger environmental footprint. The technical solutions described herein leverage AI/ML to generate, simulate and implement optimal configurations, ensuring efficient and reliable server or other IT asset operation.

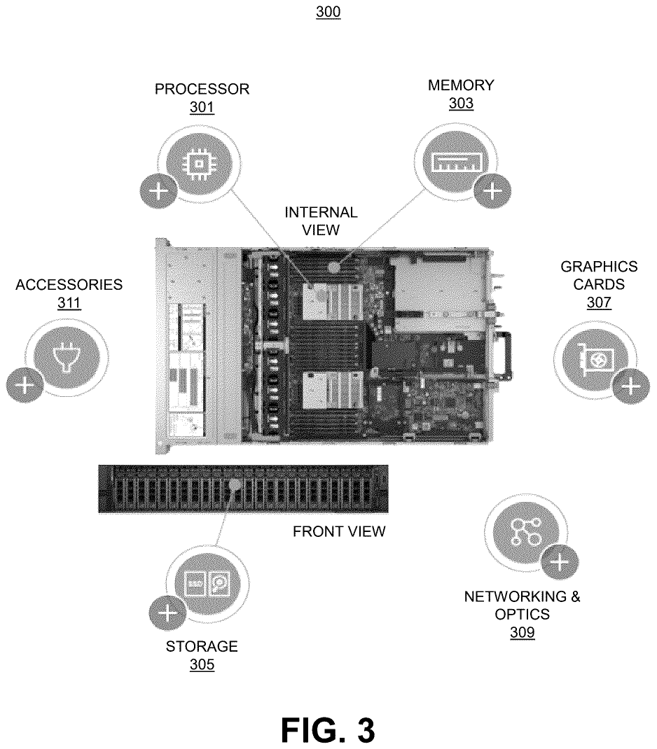

During the BIOS POST process, a Baseboard Management Controller (BMC) will begin optimizing the thermal and power configuration (e.g., for channel cards or other hardware components installed in a server or other IT asset) at each stage of device discovery and inventory. FIG. 3 illustrates an IT asset 300 (e.g., a server), with front and internal views showing various channel cards and other hardware components installed therein, including a processor 301, memory 303, storage 305, graphics cards 307, networking and optics 309, and accessories 311. A BMC of the IT asset 300, on boot-up (e.g., BIOS POST processing), will attempt to optimize the thermal and power configuration of such components. In conventional approaches, until the BIOS provides the device inventory details, the BMC will run the fans at full speed, resulting in higher power consumption and reduced efficiency.

Any new device configuration is always manually tested and validated, and hence an approach that would help to automate the validation of new device combinations is needed. In conventional approaches, the addition of new devices or components comes as a requirement and goes through the complete software development lifecycle and takes approximately three months for the release to happen. There is no optimized approach that will automatically enable the devices or components with optimal power and thermal savings. With the OCP DC-MHS architecture, the number of devices and channel cards getting added increases, and hence there is a need for technical solutions enabling easy “plug-and-play” to enable such devices and channel cards quickly with optimal configurations. In some embodiments, the technical solutions described herein meet these and other needs, though the use of vector data sets relevant to devices, channel cards or other components of IT assets and their attributes, together with a GenAI model to generate new profiles that are optimized for the operating environment.

In some embodiments, the technical solutions utilize historical data and advanced AI techniques to optimize server or other IT asset configurations, ensuring efficient and reliable operation. The technical solutions may operate the following steps or stages: (1) data collection and preprocessing, (2) AI/ML model training, (3) inventory creation and discovery, (4) optimal configuration determination and (5) implementation and monitoring. These steps or stages will be discussed in further detail below.

Data collection and preprocessing includes collecting historical data on device configurations, power consumption, thermal characteristics and operational states. The data may be cleaned and preprocessed to ensure accuracy and consistency. Relevant features are then extracted (e.g., as vectors or other data structures formatted for input to one or more AI/ML models). In some embodiments, the relevant features include unique vendor identification information, power usage information, thermal dissipation information, fan speed information and other operational information and metrics. Through leveraging CD-MHS and Modular-Peripheral Sideband Tunneling Interface (M-PESTI) discovery for peripheral devices, it is possible to identify the device class and make informed decisions without resorting to worst-case configurations (e.g., running fans at full speeds).

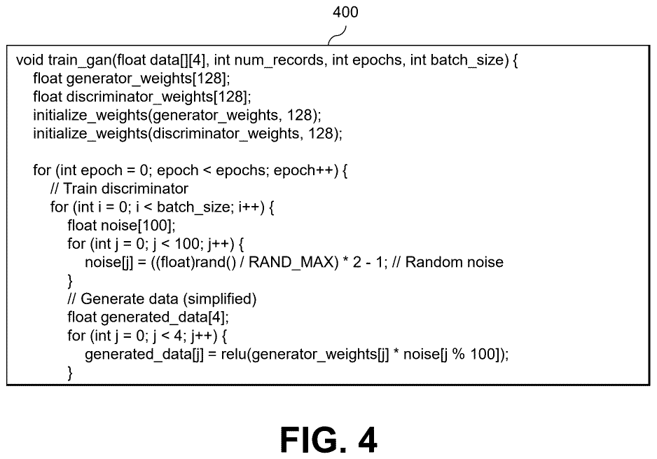

The AI/ML model training, in some embodiments, includes using a GAN model including a generator and a discriminator. The generator of the GAN model is used for generating new configurations (e.g., for hardware components of a server or other IT asset). Such generated configurations are validated using the discriminator of the GAN model. Once the configurations are generated with the training data and the preprocessed historical data, the GAN model is trained with training and testing data (e.g., of the vectors or other data structures including the extracted relevant features). The GAN model is used to learn patterns and relationships between different configurations and their optimal states. FIG. 4 shows pseudocode 400 for AI/ML model training (e.g., training a GAN model).

Inventory creation and discovery includes using the trained GAN (or other AI/ML model) to generate potential configurations for devices or components (e.g., unknown or non-standard devices or components). After such generation, the potential configurations are used to compare against the known device or component inventories to identify similarities and differences. An inventory of non-standard channel cards (or other devices or hardware components) is then created based on the generated configurations and their mapped patterns.

Optimal configuration determination includes simulating the generated configurations in a controlled environment to test their performance. The simulation results are used to make informed decisions about the optimal configurations. Real-time adjustments are then updated to provide optimal energy management during the server or other IT asset lifecycle.

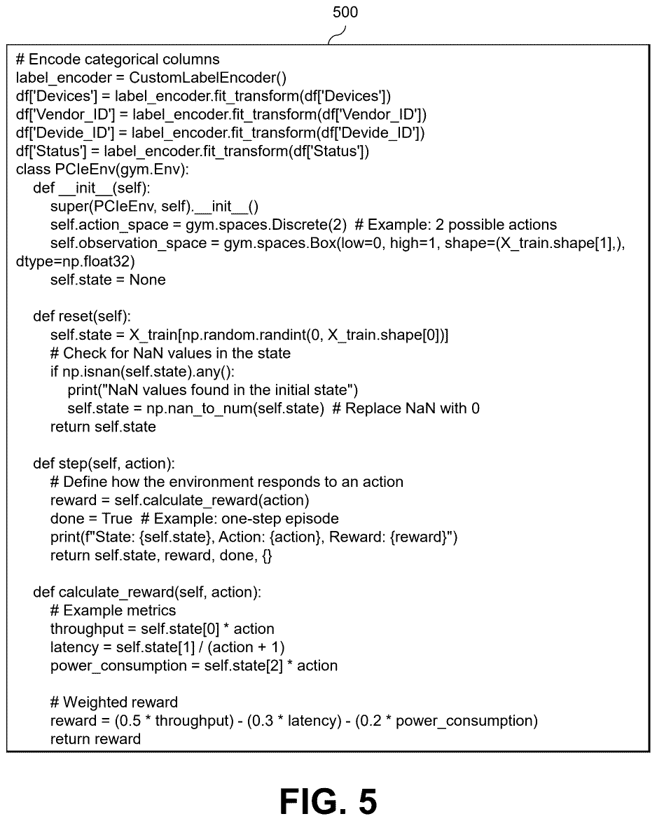

Implementation and monitoring includes performing real-time adjustments and deploying the optimal configurations in the data center or other IT infrastructure environment. Servers or other IT assets in the data center or other IT infrastructure environment are continuously monitored as they operate within desired power and thermal parameters. A feedback loop is created to continuously improve the accuracy and efficiency of generated configurations. FIG. 5 shows pseudocode 500 for inventory creation and discovery, optimal configuration determination, and implementation and monitoring.

The technical solutions described herein enable dynamic power profiling. Using DC-MHS and M-PESTI, the device class of components may be identified and used to ensure that all pre-boot decisions are optimal for hardware devices. Further, AI/ML-based dynamic inventory management is provided (e.g., using GenAI). By creating an inventory of channel devices that adheres to open standards using AI/ML-generated configurations, the technical solutions described herein are able to proactively manage device compatibility and performance. This dynamic inventory system significantly enhances operational efficiency and minimizes the risks associated with integrating modular devices with server hardware.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

Illustrative embodiments of processing platforms utilized to implement functionality for machine learning-based generation and deployment of device component configurations in IT assets will now be described in greater detail with reference to FIGS. 6 and 7. Although described in the context of system 100, these platforms may also be used to implement at least portions of other information processing systems in other embodiments.

FIG. 6 shows an example processing platform comprising cloud infrastructure 600. The cloud infrastructure 600 comprises a combination of physical and virtual processing resources that may be utilized to implement at least a portion of the information processing system 100 in FIG. 1. The cloud infrastructure 600 comprises multiple virtual machines (VMs) and/or container sets 602-1, 602-2, . . . 602-L implemented using virtualization infrastructure 604. The virtualization infrastructure 604 runs on physical infrastructure 605, and illustratively comprises one or more hypervisors and/or operating system level virtualization infrastructure. The operating system level virtualization infrastructure illustratively comprises kernel control groups of a Linux operating system or other type of operating system.

The cloud infrastructure 600 further comprises sets of applications 610-1, 610-2, . . . 610-L running on respective ones of the VMs/container sets 602-1, 602-2, . . . 602-L under the control of the virtualization infrastructure 604. The VMs/container sets 602 may comprise respective VMs, respective sets of one or more containers, or respective sets of one or more containers running in VMs.

In some implementations of the FIG. 6 embodiment, the VMs/container sets 602 comprise respective VMs implemented using virtualization infrastructure 604 that comprises at least one hypervisor. A hypervisor platform may be used to implement a hypervisor within the virtualization infrastructure 904, where the hypervisor platform has an associated virtual infrastructure management system. The underlying physical machines may comprise one or more distributed processing platforms that include one or more storage systems.

In other implementations of the FIG. 6 embodiment, the VMs/container sets 602 comprise respective containers implemented using virtualization infrastructure 604 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element may be viewed as an example of what is more generally referred to herein as a “processing device.” The cloud infrastructure 600 shown in FIG. 6 may represent at least a portion of one processing platform. Another example of such a processing platform is processing platform 700 shown in FIG. 7.

The processing platform 700 in this embodiment comprises a portion of system 100 and includes a plurality of processing devices, denoted 702-1, 702-2, 702-3, . . . 702-K, which communicate with one another over a network 704.

The network 704 may comprise any type of network, including by way of example a global computer network such as the Internet, a WAN, a LAN, a satellite network, a telephone or cable network, a cellular network, a wireless network such as a WiFi or WiMAX network, or various portions or combinations of these and other types of networks.

The processing device 702-1 in the processing platform 700 comprises a processor 710 coupled to a memory 712.

The processor 710 may comprise a microprocessor, a microcontroller, an application-specific integrated circuit (ASIC), a field-programmable gate array (FPGA), a central processing unit (CPU), a graphical processing unit (GPU), a tensor processing unit (TPU), a video processing unit (VPU), a neural processing unit (NPU), a data processing unit (DPU), a System-On-Chip (SOC) or other type of processing circuitry, as well as portions or combinations of such circuitry elements.

The memory 712 may comprise random access memory (RAM), read-only memory (ROM), flash memory or other types of memory, in any combination. The memory 712 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM, flash memory or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 702-1 is network interface circuitry 714, which is used to interface the processing device with the network 704 and other system components, and may comprise conventional transceivers.

The other processing devices 702 of the processing platform 700 are assumed to be configured in a manner similar to that shown for processing device 702-1 in the figure.

Again, the particular processing platform 700 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

As indicated previously, components of an information processing system as disclosed herein can be implemented at least in part in the form of one or more software programs stored in memory and executed by a processor of a processing device. For example, at least portions of the functionality for machine learning-based generation and deployment of device component configurations in IT assets as disclosed herein are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems, IT assets, etc. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. An apparatus comprising:
at least one processing device comprising a processor coupled to a memory;
the at least one processing device being configured:
to discover, during a boot process for an information technology asset operating in an information technology infrastructure environment, one or more component devices installed in the information technology asset;
to generate, for at least a given one of the one or more component devices installed in the information technology asset utilizing at least one machine learning model, a component configuration to be utilized for the given component device; and
to deploy, during the boot process for the information technology asset, the generated component configuration for the given component device in the information technology asset, wherein deploying the generated component configuration comprises controlling at least one of power delivery and thermal dissipation for the given component device.

2. The apparatus of claim 1 wherein the information technology infrastructure environment utilizes a data center modular hardware system (DC-MHS) architecture.

3. The apparatus of claim 1 wherein the information technology asset comprises a server.

4. The apparatus of claim 1 wherein the boot process comprises a basic input/output system (BIOS) power-on self-test (POST) process.

5. The apparatus of claim 1 wherein discovering the given component device installed in the information technology asset comprises utilizing a sideband interface to determine a device class of the given component device.

6. The apparatus of claim 5 wherein the sideband interface comprises a modular peripheral sideband tunneling interface (M-PESTI).

7. The apparatus of claim 1 wherein the given component device comprises a channel card which is not validated by a vendor of the information technology asset.

8. The apparatus of claim 1 wherein the given component device comprises a non-standard component device not associated with a known component configuration.

9. The apparatus of claim 1 wherein the at least one machine learning model comprises a generative adversarial network (GAN) machine learning model.

10. The apparatus of claim 9 wherein the GAN machine learning model is trained utilizing historical data collected for a plurality of component devices, the historical data characterizing component device configurations, power consumption, thermal characteristics and operational states of the plurality of component devices.

11. The apparatus of claim 1 wherein the generated component configuration for the given component device specifies at least one of power usage and thermal dissipation characteristics of the given component device.

12. The apparatus of claim 11 wherein deploying the generated component configuration for the given component device comprises controlling a speed of one or more fans of the information technology asset based at least in part on the power usage and thermal dissipation characteristics of the given component device.

13. The apparatus of claim 1 wherein, prior to deploying the generated component configuration for the given component device, one or more fans of the information technology asset are operated at a first speed, and wherein deploying the generated component configuration for the given component device comprises adjusting the one or more fans of the information technology asset to operate at a second speed, the second speed being less than the first speed.

14. The apparatus of claim 13 wherein the first speed comprises a maximum speed of the one or more fans.

15. A computer program product comprising a non-transitory processor-readable storage medium having stored therein program code of one or more software programs, wherein the program code when executed by at least one processing device causes the at least one processing device:
to discover, during a boot process for an information technology asset operating in an information technology infrastructure environment, one or more component devices installed in the information technology asset;
to generate, for at least a given one of the one or more component devices installed in the information technology asset utilizing at least one machine learning model, a component configuration to be utilized for the given component device; and
to deploy, during the boot process for the information technology asset, the generated component configuration for the given component device in the information technology asset, wherein deploying the generated component configuration comprises controlling at least one of power delivery and thermal dissipation for the given component device.

16. The computer program product of claim 15 wherein the at least one machine learning model comprises a generative adversarial network (GAN) machine learning model, and wherein the GAN machine learning model is trained utilizing historical data collected for a plurality of component devices, the historical data characterizing component device configurations, power consumption, thermal characteristics and operational states of the plurality of component devices.

17. The computer program product of claim 15 wherein, prior to deploying the generated component configuration for the given component device, one or more fans of the information technology asset are operated at a first speed, and wherein deploying the generated component configuration for the given component device comprises adjusting the one or more fans of the information technology asset to operate at a second speed, the second speed being less than the first speed.

18. A method comprising:
discovering, during a boot process for an information technology asset operating in an information technology infrastructure environment, one or more component devices installed in the information technology asset;
generating, for at least a given one of the one or more component devices installed in the information technology asset utilizing at least one machine learning model, a component configuration to be utilized for the given component device; and
deploying, during the boot process for the information technology asset, the generated component configuration for the given component device in the information technology asset, wherein deploying the generated component configuration comprises controlling at least one of power delivery and thermal dissipation for the given component device;
wherein the method is performed by at least one processing device comprising a processor coupled to a memory.

19. The method of claim 18 wherein the at least one machine learning model comprises a generative adversarial network (GAN) machine learning model, and wherein the GAN machine learning model is trained utilizing historical data collected for a plurality of component devices, the historical data characterizing component device configurations, power consumption, thermal characteristics and operational states of the plurality of component devices.

20. The method of claim 18 wherein, prior to deploying the generated component configuration for the given component device, one or more fans of the information technology asset are operated at a first speed, and wherein deploying the generated component configuration for the given component device comprises adjusting the one or more fans of the information technology asset to operate at a second speed, the second speed being less than the first speed.
